(19) United States
(12) Patent Application Publication
(10) Pub. No.: US 2022/0120383 A1
(43) Pub. Date: Apr. 21, 2022

(54) DEVICE AND METHOD FOR FILLING PRESSURIZED GAS TANKS

(71) Applicant: L'Air Liquide, Societe Anonyme pour l'Etude et l'Exploitation des Procedes Georges Claude, Paris (FR)

(72) Inventors: Etienne WERLEN, Sassenage (FR); Clemence DEVILLIERS, Sassenage (FR)

(73) Assignee: L'Air Liquide, Societe Anonyme pour l'Etude et l'Exploitation des Procedes Georges Claude, Paris (FR)

(21) Appl. No.: 17/501,294

(22) Filed: Oct. 14, 2021

(30) Foreign Application Priority Data
Oct. 16, 2020 (FR) FR 2010622

(51) Int. Cl. F17C 5/06; F17C 13/04

(52) U.S. Cl. CPC F17C 5/06; F17C 13/04; F17C 2221/012; F17C 2260/021; F17C 2270/0178; F17C 2205/0335; F17C 2205/0388; F17C 2227/043

(57) ABSTRACT

Pressurized gas tanks are filled from at least one gas source using a transfer circuit, a set of buffer storage tanks and at least one compressor. The set of buffer storage tanks may be filled with pressurized gas from the at least one gas source by pressure balancing via balancing lines without going through the at least one compressor. The set of buffer storage tanks may also be filled with pressurized gas from the at least one gas source that is compressed by the at least one compressor.

### CROSS-REFERENCE TO RELATED APPLICATIONS

This application claims the benefit of priority under 35 U.S.C. § 119 (a) and (b) to French patent application No. FR 2 010 622, filed Oct. 16, 2020, the entire contents of which are incorporated herein by reference.

### BACKGROUND

### Field of the Invention

The invention relates to a device and a method for filling pressurized gas tanks.

The invention relates more particularly to a device for filling pressurized gas tanks, in particular hydrogen gas tanks of motor vehicles, the device comprising at least one gas source, a transfer circuit comprising at least one upstream end connected to the source and at least one downstream distribution end suitable for being removably connected to a tank to be filled, the device comprising a set of buffer storage tank(s) connected in parallel to the transfer circuit between the upstream and downstream ends via a set of respective connecting valve(s), the transfer circuit further comprising at least one compressor, the compressor having an intake inlet connected to the upstream end of the circuit via at least one upstream valve, the compressor comprising a discharge outlet connected to the buffer storage tank(s) via a set of discharge valve(s).

### Related Art

Such a filling station is typically provided with a set of stationary buffer tanks that are filled by the source (generally transportable and typically a semi-trailer carrying large high-pressure storage tanks) and/or using one or more compressors.

When the source is at a higher pressure than one of the buffer storage tanks, it is not possible or not desirable to transfer gas from the source to the buffer storage tank through the compressor. If higher pressure is applied at the suction of a compressor than at the discharge, there is a risk that the valves of the compressor will open and be caused to flutter, which quickly damages them. In addition, there is a risk of excessively rapid transfer and excessively high speeds in the pipes.

Optimizing the use of a positive-displacement compressor for the performance of the station leads to the use of certain buffer storage tanks at the suction of the compressor when the source at low pressure. With this type of operation, it has been observed that when the source is coming to the end of its use, the pressure of certain buffer storage tanks is relatively low. After the source has been changed (full for empty), a situation can arise in which the source is at higher pressure than certain buffer storage tanks. This prohibits the use of these buffer storage tanks until the pressure of the source has fallen sufficiently to allow transfer to these buffer storage tanks through the compressor. This is particularly the case with high-pressure sources (300 bar, 450 bar or 650 bar or more).

### SUMMARY OF THE INVENTION

One aim of the present invention is to overcome all or some of the drawbacks of the prior art identified above.

To this end, the device according to the invention, which also meets the generic definition given of it in the preamble above, is mainly characterized in that the circuit comprises balance lines connecting the at least one upstream end of the circuit to the buffer storage tank(s), said balance lines comprising a flow limiting member and being configured to allow the transfer of a stream of fluid from the source to the buffer storage tank(s) by pressure balancing.

By installing calibrated orifices or equivalent (that is, an element creating a restriction on the passage of the fluid in order to limit its flow, for example, a small-diameter pipe or a regulating needle valve) and optionally control valves, the invention allows gas to be transferred safely from the source to the buffer storage tanks. Transfer through the compressor can thus be avoided when the pressure differential is unsuitable.

The circuit is preferably provided with (a) non-return valve(s). The valves of the circuit can be controlled to guide the flow through these flow limiting members in order to transfer hydrogen to a buffer storage tank when the pressure in the source is relatively higher.

The use of the compressor can thus be prohibited and avoided for filling the buffer storage tanks when the suction pressure is higher than the discharge pressure.

Furthermore, embodiments of the invention can include one or more of the following features:
the intake inlet of the compressor is also connected to the buffer storage tank(s) via a set of intake valve(s),
the balance lines comprise separate portions of at least part of the circuit connecting the intake inlet of the compressor to the buffer storage tanks via the set of intake valve(s),
the balance lines each comprise an isolation valve and/or a non-return valve in series with the flow limiting member,
the source comprises at least one of: one or more pressurized gas storage tanks, in particular mobile storage tanks, a pressurized gas network, a liquefied gas storage tank associated with a heater and/or a pump, and an electrolyser,
the device comprises a plurality of buffer storage tanks connected in parallel to the at least one upstream end via respective balance lines and respective flow limiting members,
the buffer storage tanks are connected in parallel to the at least one downstream end via respective downstream lines and the respective connecting valve(s),
the compressor intake inlet is connected to each of the buffer storage tanks via separate suction lines each comprising an intake valve,
the circuit comprises a plurality of separate downstream distribution ends,
the circuit comprises a plurality of upstream ends connected in parallel to the source and a set of controlled valve(s) configured to select the gas source or sources supplying the transfer circuit.

The invention also relates to a method for filling pressurized gas tanks, in particular hydrogen gas tanks of motor vehicles, using a device according to any one of the features above or below, the method including a step of transferring pressurized gas from the source to a buffer storage tank to be filled by pressure balancing via a balance line and a flow limiting member.

According to one possible particular feature, the method includes a step of comparing the pressure of the source and the pressure of the buffer storage tank to be filled and, when the pressure of the source is higher than the pressure of the buffer storage tank to be filled by a predetermined value, the pressurized gas is transferred from the source to the buffer storage tank to be filled by pressuring balancing via a balance line and a flow limiting member and, when the pressure of the source is lower than the pressure of the buffer storage tank to be filled with a predetermined pressure tolerance, preferably less than 10 MPa, the pressurized gas is transferred from the source to the buffer storage tank via the compressor.

The invention can also relate to any alternative device or method comprising any combination of the features above or below within the scope of the claims.

### BRIEF DESCRIPTION OF THE FIGURES

Further particular features and advantages will become apparent upon reading the description below, which is given with reference to the figures, in which:

FIG. 1 shows a partial schematic view illustrating one example of the structure and operation of a device according to the invention.

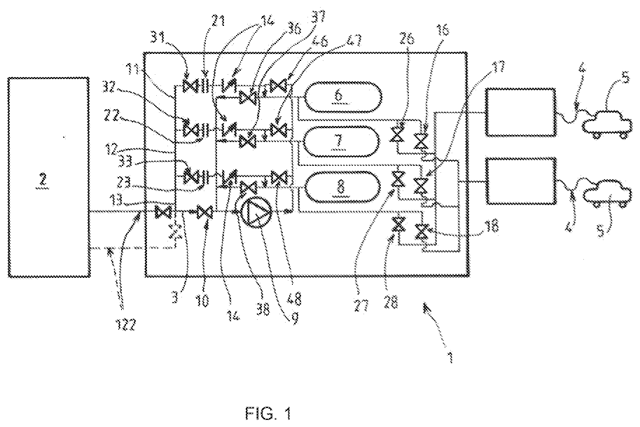

### DETAILED DESCRIPTION OF THE INVENTION

The device 1 for filling pressurized gas tanks illustrated is, for example, a station for filling hydrogen gas tanks of motor vehicles.

The device 1 comprises at least one gas source 2 and one transfer circuit 3 comprising at least one upstream end 122 connected to the source 2 and at least one downstream distribution end 4 suitable for being removably connected to a tank 5 to be filled (for example via a flexible hose provided with a nozzle).

The source 2 typically comprises one or more pressurized gas storage tanks in particular mobile storage tanks (mounted on a semi-trailer, for example). Of course, any other type of source can be envisaged (a pressurized gas network, a liquefied gas storage tank associated with a heater and/or a pump, an electrolyser, etc.).

In addition, a plurality of sources 2 can be provided and can be connected in parallel to the upstream end 122 or to a plurality of separate upstream ends 122 of the transfer circuit. The device 1 is preferably configured to select between a plurality of sources of filling gas connected in parallel.

For example, several mobile storage tanks (trailers) or several compartments of the same mobile storage tank can be connected to the suction of the compressor or be used for a transfer to a buffer storage tank via a set of appropriate valve(s).

The device 1 comprises a set of buffer storage tanks 6 to 8 connected in parallel to the transfer circuit 3 between the upstream and downstream ends via a set of respective connecting valve(s) 16 to 18, 26 to 28. In this example, three buffer storage tanks 6, 7, 8 are shown, but just one, two or more than three can be envisaged. Preferably, these buffer storage tanks 6 to 8 are fixed or stationary.

The transfer circuit 3 further comprises a compressor 9 provided with an intake inlet connected to the upstream end of the circuit 3 via at least one upstream valve 10. In other words, the compressor 9 can be supplied with gas coming directly from the source 2.

This intake inlet of the compressor 9 can also be connected to the buffer storage tanks 6 to 8 via a set of respective intake valves 36 to 38. In other words, the compressor 9 can be supplied with gas coming from the buffer storage tanks 6 to 8. For example, the intake inlet of the compressor 9 is connected to each of the buffer storage tanks 6 to 8 via separate suction lines each comprising an intake valve 36 to 38.

The compressor 9 comprises a compressed gas discharge outlet connected to the buffer storage tank(s) 6 to 8 via a set of respective valve(s) 46 to 88. In other words, the compressor can fill the buffer storage tanks 6 to 8.

The buffer storage tanks 6 to 8 are connected in parallel to the downstream ends 4. This makes it possible, for example, to fill tanks 5 by pressure balancing (in particular using the cascade principle). For example, the buffer storage tanks 6 to 8 are connected in parallel to the downstream end 4 via respective downstream lines and respective connecting valves 16 to 18, 26 to 28 allowing each downstream end 4 to be supplied by any one of the buffer storage tanks (optionally even by more than one simultaneously).

Likewise, preferably, the discharge outlet of the compressor 9 can also be connected to the downstream ends 4 of the circuit in order to transfer pressurized gas directly into the tanks 5 (optionally simultaneously with a transfer by the buffer storage tanks 6 to 8).

The circuit 3 further comprises balance lines 11, 12, 13 connecting the upstream end 122 of the circuit 3 to the buffer storage tanks 6, 7, 8. These balance lines 11, 12, 13 comprise a flow limiting member 21, 22, 23 (calibrated orifice or other member) and are configured to allow the transfer of a stream of fluid from the source 2 directly to the buffer storage tank(s) 6, 7, 8 by pressure balancing (without passing through the compressor 9).

As illustrated, the balance lines 11, 12, 13 preferably comprise separate portions of at least part of the circuit 3 connecting the intake inlet of the compressor 9 to the buffer storage tanks 6 to 8 via the set of intake valve(s). For example, the dedicated lines are connected in parallel to the upstream end 122 of the circuit 3.

As illustrated, each balance line 11, 12, 13 associated with a buffer storage tank can include a respective isolation valve 31, 32, 33 and/or a respective non-return valve 14 in series with a respective flow limiting member.

Of course, as a variant, all or some of these members could be shared in a portion of circuit common to the balance lines 11, 12, 13.

Such an arrangement makes it possible to fill the buffer storage tanks 6 to 8 by pressure balancing with the source 2 when the pressure of the source 2 is higher than that of said buffer storage tank to be filled. When the pressure of the source 2 is equal or close to that of the buffer storage tank to be filled, the transfer and filling can be undertaken using a compressor 9.

The filling of the buffer storage tanks 6 to 8 can thus use a dedicated balance line 11, 12, 13 when the pressure in a transportable source 2 is higher than that of the buffer storage tank in question and use a transfer through the compressor 9 when the pressure in a transportable source 2 is close to or lower than that of the buffer storage tank 6 to 8.

For example, the transfer takes place via the compressor 9 when the pressure of the source 2 is lower than the pressure of the buffer storage tank to be filled with a predetermined pressure tolerance, preferably less than 10 MPa (100 bar), for example less than or equal to 1 MPa (10 bar). In other words, the compressor 9 can be used for a transfer between the source 2 and the buffer storage tank if, for example, the source is at 30 MPa (300 bar) and the buffer storage tank is at a pressure of more than 29 MPa (290 bar).

The presence of a flow limiting member 21, 22, 23 in the balance lines 11, 12, 13 prevents excessively sudden pressure rises. The presence of a non-return valve in the balance lines 11, 12, 13 is a preferred embodiment that makes it possible to prevent fluid from returning to the compressor 9.

All or some of these transfers can be automated, for example via the use of controlled valves.

If necessary for various optimizations, this logic can be combined with other criteria in order to control the gas transfers in the station.

This architecture and use makes it possible to fill buffer storage tanks safely, for example during a mode of non-use of the device (no filling of a tank 5) and/or during filling of a tank 5, if applicable. The buffer storage tanks filled in this way can be used to transfer pressurized gas during the filling of a tank 5.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A device for filling pressurized gas hydrogen tanks, comprising: at least one gas source; a transfer circuit comprising at least one upstream end connected to the source and at least one downstream distribution end suitable for being removably connected to a tank to be filled; a set of buffer storage tanks connected in parallel to the transfer circuit between the upstream and downstream ends via a set of respective connecting valves, wherein:
the transfer circuit further comprises at least one compressor having an intake inlet connected to the upstream end of the circuit via at least one upstream valve and a discharge outlet connected to the plurality of buffer storage tanks via a set of discharge valves;
the circuit comprises balance lines connecting the at least one upstream end of the circuit to the plurality of buffer storage tanks;
each of the balance lines comprises a flow limiting member; and
the balance lines are configured to allow a transfer of a stream of fluid from the source to the buffer storage tank(s) by pressure balancing.

2. The device of claim 1, wherein the compressor intake inlet is also connected to the plurality of buffer storage tanks via a set of intake valves.

3. The device of claim 2, wherein the balance lines comprise separate portions of at least part of the circuit connecting the intake inlet of the compressor to the plurality of buffer storage tanks via the set of intake valves.

4. The device of claim 1, wherein each of the balance lines comprises an isolation valve and/or a non-return valve in series with the flow limiting member.

5. The device of claim 1, wherein the at least one source comprises at least one of: one or more mobile pressurized gas storage tanks; a pressurized gas network; a liquefied gas storage tank that is associated with a heater and/or a pump; and an electrolyser.

6. The device of claim 1, wherein each of the set of buffer storage tanks is connected in parallel to the at least one upstream end via a respective one of the balance lines.

7. The device of claim 6, wherein each of the set of buffer storage tanks is connected in parallel to the at least one downstream end via a respective downstream line and the respective connecting valves.

8. The device of claim 6, wherein the intake inlet of the compressor is connected to each of the buffer storage tanks via separate suction lines each comprising an intake valve.

9. The device of claim 1, wherein the at least one downstream distribution end comprises a plurality of downstream distribution ends.

10. The device of claim 1, wherein the at least one gas source comprises a plurality of gas sources, the at least one upstream end comprises a plurality of upstream ends connected in parallel to plurality of gas sources and a set of controlled valves that are configured to select one of the plurality of gas source to supply the transfer circuit.

11. A method for filling pressurized gas tanks using the device of claim 1, comprising the steps of: transferring pressurized gas from the at least one gas source to the set of buffer storage tanks to be filled by pressure balancing via the balance lines and flow limiting members and/or via the compressor; and transferring pressurized gas from the set of buffer storage tanks to the pressurized gas hydrogen tanks via the at least one downstream distribution end.

12. The method of claim 11, further comprising a step of comparing a pressure of the source and a pressure of the set of buffer storage tanks to be filled, wherein:
when the pressure of the source is higher than the pressure of the set of buffer storage tanks to be filled by a predetermined value, the pressurized gas is transferred from the at least one gas source to the set of buffer storage tanks to be filled by pressuring balancing via a balance line and a flow limiting member; and
when the pressure of the source is lower than the pressure of the buffer storage tank to be filled with a predetermined pressure tolerance the pressurized gas is transferred from the source to the buffer storage tank via the compressor.

13. The method of claim 11, wherein the predetermined pressure tolerance is less than 10 MPa.

14. The method of claim 11, wherein the pressurized gas tank is a pressurized hydrogen gas tank of a motor vehicle.
